(19) United States
(12) Patent Application Publication
(10) Pub. No.: US 2006/0287735 A1
(43) Pub. Date: Dec. 21, 2006

(54) Multifunctional system for application in home automation

(76) Inventor: Julian Victorio Garcia, Barcelona (ES)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/157,443

(22) Filed: Jun. 21, 2005

(51) Int. Cl. G05B 11/01; G05B 19/18

(52) U.S. Cl. 700/19; 700/65; 700/66; 700/20

(57) ABSTRACT

This system comprises a central unit (1) responsible for controlling the system and to which are connected: an intercom unit (2), an electronic learning unit (3), a consumption management unit (4), a receiver link unit (5), a simulation unit (6) which reproduces facial images with voice through a plasma display or screen, a push button unit (7), a telephone management unit (8) and an emitter and receiver volume control unit (9).

### OBJECT OF THE INVENTION

The present invention refers to a multifunctional system for application in home automation, of the type comprising a series of circuits distributed in different locations in the building, all of them being controlled by a central unit responsible for controlling the system and a series of peripheral units.

### BACKGROUND OF THE INVENTION

There are different home automation systems currently in the market that are applicable to buildings and generally comprising a central unit responsible for controlling the system and managing the different elements associated thereto.

These home automation systems currently include the elements necessary to perform certain functions such as: programming outputs according to a weekly schedule, controlling electrical appliances, detecting intrusion, telephone searching, voice mail recording or activating and deactivating system functions by remote control.

These functions are insufficient to meet current needs and to allow establishing an adequate communication between the user and other people who may have access to the system or to perform additional functions such as: an intelligent management of electrical appliances, lighting devices or any other equipment with respect to the habits of the user.

### DESCRIPTION OF THE INVENTION

In order to solve the mentioned drawbacks a multifunctional home automation action system has been devised, which being of the aforementioned type includes a series of functional units intended for allowing: establishing voice communication between the user and other people through the system, rationalising system performance according to the needs of the user and performing other additional functions such as managing consumption of electrical appliances or other equipment installed in the home and the possibility that the system may offer different responses through signals generated by means of push buttons distributed in different points in the home.

To this end it has been provided that the system comprises the following functional units: an intercom unit, an electronic learning unit, a consumption management unit, a receiver link unit, a simulation unit, a push button unit, a telephone management unit and a volume control unit.

It is provided that the intercom unit responsible for managing the audio, video and messaging signals between an external board connected by cable to the central unit of the system and an inner board allowing to establish direct communication between the user and the visitor, having further provided that said intercom unit shall incorporate a hands-free device allowing establishing the communication from inside the home through ambient loudspeakers and microphones, and a telephone dialler allowing establishing a mobile telephone connexion with a remote user when the latter is not within the building.

This intercom unit therefore allows establishing communication between the visitor and the user, regardless of whether the latter is within the building or outside it and the possibility of leaving recorded messages for later listening.

The electronic learning unit connected to the central unit is responsible for performing statistics on different system actions such as: activating and deactivating outputs, system connections, activating and deactivating messages or on any other function repetitively performed by the system, said unit automatically adapting the functions performed by the system to the needs of the user according to the results of the statistics performed.

This electronic learning unit allows the system to perform repetitive functions in a completely automatic manner and in a suitable schedule for them, this unit being able to analyse and re-calculate the statistics with a certain frequency in order to adapt the functions to be performed automatically to the needs of the user.

The consumption management unit has remotely controlled outputs for controlling electrical appliances and various equipment such that once the user has programmed his or her desired operation for the electrical appliances or equipment in the home, manually connecting them being sufficient for this purpose, the board will be programmed to always activate them with the same frequency, detecting consumption excesses and preventing electrical appliances from working at the same time, thus preventing power surges and possibly obtaining other advantages such as making the best use of reduced power supply rates.

The receiver link unit to which the entire audio system is connected allows performing connection and two-way radio communication between the system and a remote receiver.

The simulation unit associated to the system central unit is responsible for reproducing facial images with voice through a plasma display or screen such that the user may see the image of the interlocutor on said screen when a connection is established through the system.

The push button unit allows the system to offer different responses such as controlling the light, heating, electrical appliances or other equipment according to the signals received and generated by means of actuation of one of the push buttons distributed in different locations in the home.

This unit allows analysing the signals received according to the type and number of times a button is pressed, in each case activating an output associated to the type of push button pressed and therefore activating the corresponding response in the system.

This unit allows obtaining different system responses according to the number, type (long or short) and combination of the push buttons pressed by the user, providing in any case the appropriate response to the signal or combination of signals received.

The telephone management unit allows using the system in hands-free mode, recognising the telephone number, activating the telephone through voice, diverting calls between incoming telephones and those of the user's phonebook, as well as managing voice messages associated to telephones of the user's phonebook.

Finally, the volume control unit is responsible for automatically controlling the volume of communications established between the transmitter and the receiver, graduating transmission and reception intensity by means of stable noise, as well as controlling the loudspeaker volume towards the external speakers and the reverse in programmed time.

### DESCRIPTION OF THE DRAWINGS

In order to complement the description being made and with the object of aiding understanding of the features of the invention, a set of drawings is attached to this specification in which the following is shown with an illustrative and non-limiting character:

FIG. 1 shows a block diagram of the multifunctional system for application in home automation object of the invention.

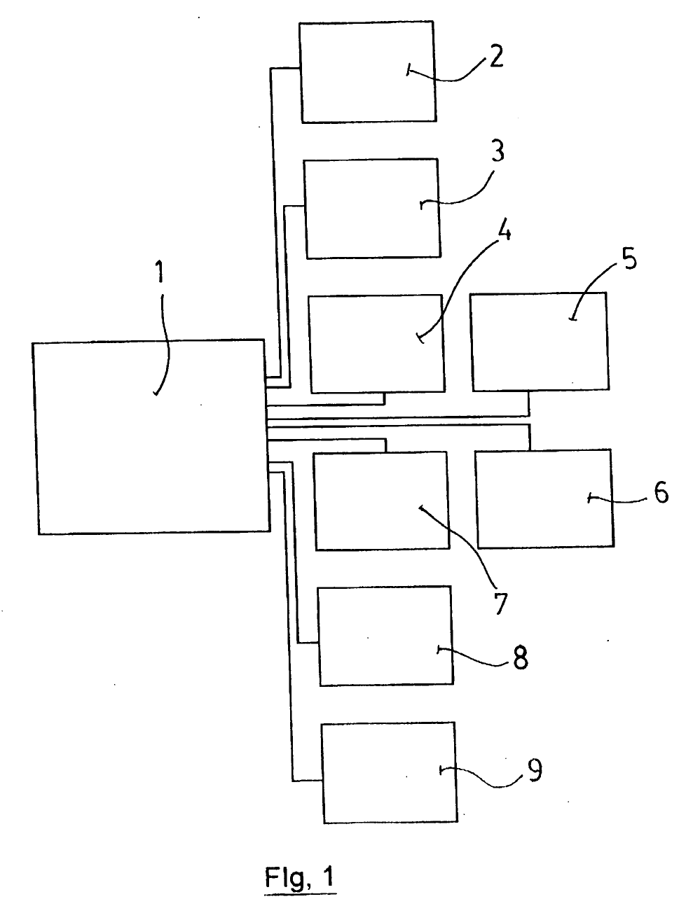

### PREFERRED EMBODIMENT OF THE INVENTION

As can be seen in the attached figure, the multifunctional system for application in home automation comprises a central unit (1) to which an intercom unit (2), an electronic learning unit (3), a consumption management unit (4), a receiver link unit (5), a simulation unit (6), a push button unit (7), a telephone management unit (8) and a transmitter and receiver volume control unit (9) are connected.

The intercom unit (2) allows establishing audio and video communication between an external board located outside the home and an internal board.

Said intercom unit (2) also allows establishing communication from inside the home through a hands-free device with ambient microphones and loudspeakers.

The electronic learning unit (3) is responsible for memorising the behaviour of each user automatically activating those system functions which are repetitively executed at specific schedules, said electronic learning unit being responsible for statistically determining the activation frequency and schedule for said functions.

The consumption management unit (4) allows the system to activate electrical appliances or other equipment always in the same frequency, further detecting excessive consumption and preventing said equipment from working at the same time in order to prevent power surges.

The receiver link unit (5) to which the entire audio system is connected allows establishing two-way radio voice communication with a receiver.

The simulation unit (6) allows simulating a face with voice through a plasma display or screen, allowing the user to see his interlocutor.

The push button unit (7) is responsible for controlling operation of electrical appliances, lighting or other elements by the system according to the number, type and frequency of the signals received and generated by the user by means of actuating push buttons distributed throughout the building.

The telephone management unit (8) allows using the system in hands-free mode recognising the telephone number, actuating the telephone through voice, diverting calls between incoming calls and those of the user's phonebook and managing voice messages associated to the telephones of the user's phonebook.

Finally, the volume control unit (9) is responsible for automatically controlling the receiver and transmitter volume, graduating the transmission and reception intensity thereof.

Having sufficiently described the nature of the invention as well as a preferred embodiment thereof, it is hereby stated that the materials, shape, size and arrangement of the described elements may be modified as long as this does not mean an alteration of the essential features of the invention claimed below.

1.- A multifunctional system for application in home xautomation made up of a series of circuits distributed in different locations in the building, all of them being controlled by a central unit (1) responsible for controlling the system and a series of peripheral units, characterised in that it comprises the following functional units:
an intercom unit (2) managing audio, video and messaging signals between an external board and an internal board provided with a hands-free device and/or a telephone dialler responsible for establishing a mobile telephone connection with a remote user when he or she is not in the building
an electronic learning unit (3) memorising the behaviour of each user adapting system performance to his or her needs;
a consumption management unit (4);
a receiver link unit (5) including the entire audio system and establishing two-way communication between the system and a remote receiver;
a simulation unit (6) reproducing facial images with voice through a plasma display or screen;
a push button unit (7) allowing controlling electrical appliances, lighting and other services by the system by receiving signals from different push buttons distributed throughout the building;
a telephone management unit (8) with a hands-free function and voice-activation;
a receiver and transmitter volume control unit (9) automatically controlling transmission and reception intensity.
